(19) United States
(12) Patent Application Publication
(10) Pub. No.: US 2013/0004810 A1
(43) Pub. Date: Jan. 3, 2013

(54) BATTERY CELL PROTECTION DEVICE OF ECO-FRIENDLY VEHICLE

(75) Inventors: Haekyu Lim, Seoul (KR); Junho Bang, Hwaseong (KR); Yooncheol Jeon, Suwon (KR); Jinho Park, Seoul (KR); Sukhyung Kim, Hwaseong (KR)

(73) Assignees: Kia Motors Corporation, Seoul (KR); Hyundai Motor Company, Seoul (KR)

(21) Appl. No.: 13/274,746

(22) Filed: Oct. 17, 2011

(30) Foreign Application Priority Data
Jun. 30, 2011 (KR) 10-2011-0064709

(51) Int. Cl. H01M 10/42

(52) U.S. Cl. 429/61

(57) ABSTRACT

Provided is a battery cell protection device for a vehicle equipped with a battery pack composed of battery cells and a battery management system that manages power of the battery pack. In particular, the battery cell protection device includes a wiring harness accommodating a plurality of wires connecting the battery cell with the battery management system; and fuses disposed on the wires of the wiring harness. These fuse are configured to be cut by an abnormally high voltage so that when an external impact or shock is applied to the cell module, ignition of an explosion due to a short circuit in the wires connected with the batter cells is precluded, thereby ensuring driver and passenger safety.

### CROSS-REFERENCE TO RELATED APPLICATIONS

The present application claims priority to Korean Patent Application Number 10-2011-0064709 filed Jun. 30, 2011, the entire contents of which application is incorporated herein for all purposes by this reference.

### BACKGROUND OF THE INVENTION

1. Field of the Invention

The present invention relates to a battery cell protection device for an eco-friendly vehicle such as an electric vehicle or a hybrid vehicle, and more particularly, to a battery cell protection device of an eco-friendly vehicle that can prevent damage to the battery cell by shutting out abnormally high voltage from the battery cell.

2. Description of Related Art

Recently, eco-friendly vehicles equipped with a battery (i.e., hybrid vehicles and electric vehicles etc.) have become a significant market for most automotive manufacturers. In these eco-friendly vehicles, the capacity of batteries has been gradually increased to improve fuel efficiency and traveling performance of the cars as a whole. With the increase in capacity of the batteries, technologies for ensuring safety against high voltage have been developed as a result. The car manufacturers and battery manufacturers have reinforced the specifications of vehicles and items within these vehicles in order to prevent explosion due to a collision and/or electric short.

One technology for protecting a battery cell against high voltage is employ a receptacle that is fixed to each of plurality of cell pouch electrodes to sense voltage and a connector that can sense voltage. The voltage sensing connector is disposed at a wiring harness connected with the electrode of the battery. In this technology, when the voltage sensing line in a cell module is disconnected by damage to the coating due to a car collision or a shock, the BMS (Battery Management System) diagnoses the disconnection. However, currently it is impossible to completely prevent a battery cell from exploding. Furthermore, in an electric vehicle or a plug-in battery, since the cell capacity is larger than in the existing hybrid vehicles [HEV], there is an even greater danger associated with an explosion.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

The present invention has been made in an effort to provide a battery cell protection device for an eco-friendly vehicle that can ensure human safety by precluding igniting an explosion due to a short circuit in a wire connected to the battery cell, when an external impact or shock is applied to the cell module. In particular, an exemplary embodiment of the present invention provides a battery cell protection device of an eco-friendly vehicle, in a battery for a vehicle equipped with a battery pack that is composed of battery cells and a battery management system that manages power of the battery pack. The battery cell protection device includes: a wiring harness accommodating a plurality of wires connecting the battery cell with the battery management system; and fuses disposed on the wires of the wiring harness and broken by abnormally high voltage, in which the fuse is bonded to both opposite ends of the wire.

More specifically, the wiring harness may include a plurality of high-voltage wires separately disposed, lead wires connected with the high-voltage wires by the fuses, and retracting tubes covering and fixing the high-voltage wires, the lead wires, and the fuses. The wiring harness may be disposed at a lower side of the battery pack to be replaceable. The thickness of the fuse may be about 2.3 mm to 2.5 mm. An insulator may be disposed between the fuses.

The present invention has the advantage of being able to ensure human safety by precluding ignition of an explosion due to a short circuit in a wire connected with a battery cell, when an external impact or shock is applied to a cell module.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic enlarged view of a battery cell protection device of an eco-friendly vehicle according to an exemplary embodiment of the present invention.

FIG. 2 is a view schematically showing the configuration of a wiring harness of FIG. 1.

FIG. 3 is a circuit diagram of a battery cell protection device of an eco-friendly vehicle according to an exemplary embodiment of the present invention.

FIG. 4 is a view showing when a short circuit has occurred in FIG. 3.

FIG. 5 is a view showing a cartridge type fuse according to an exemplary embodiment of the present invention.

FIG. 6 is a view showing a blade type fuse according to an exemplary embodiment of the present invention.

FIG. 7 is a perspective view showing a voltage sensing line of a battery pack where the cartridge type fuse and the blade type fuse according to an exemplary embodiment of the present invention can be applied.

FIG. 8 is a view showing a modified example of the battery cell protection device according to an exemplary embodiment of the present invention, in which a PCB is additionally provided.

FIG. 9 is an enlarged view of the portion A shown in FIG. 8.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

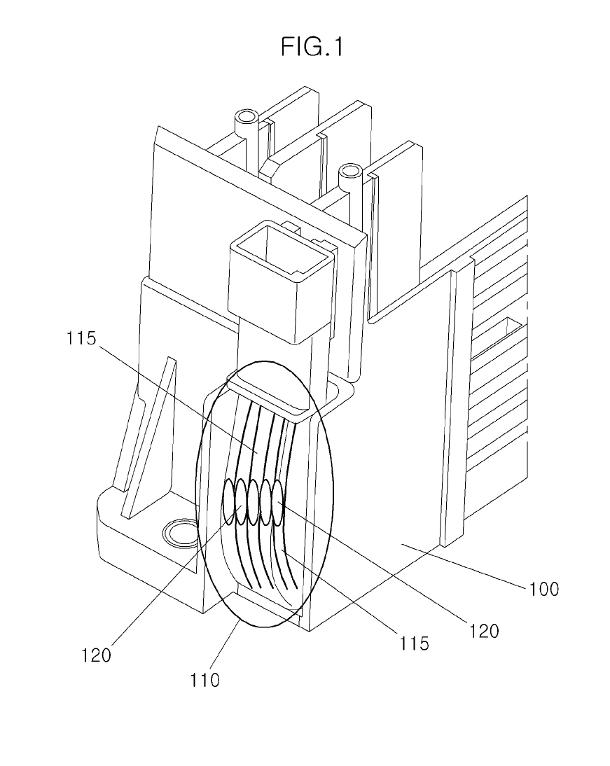

Referring to FIGS. 1 to 3, a battery cell protection device of an eco-friendly vehicle according to an exemplary embodiment may include a fuse 120 that protects a battery cell by shutting off or cutting the current accompanying high voltage between a battery pack 100 including a battery cell 102 and a battery management system 105 that manages the power of battery pack 100. The fuse 120 may be disposed within a plurality of wires 115 disposed in a wiring harness 110 connecting the battery cell 102 with the battery management system 105. Unlike that shown in the figure, about nine wires 115 may be disposed in the wiring harness 110. The fuse 120 provides an electrical connection structure for the wires 115 vertically arranged and can shut off current flowing to the battery cell 102 by being “cut” when an abnormally high voltage is generated and received.

The fuse 120 may be made of lead that can be melted and broken under an abnormally high voltage, in the wires 115 of the wiring harness 110, and may be disposed within the device by bonding the fuse 120 at both opposite connection ends with the wire 115. One or more fuses 120 may be disposed for each wire 115, and an insulator (not shown) may be disposed between the fuses. Alternatively, the fuse(s) 120 may be coated with an insulator (not shown), so that it is possible to prevent a short circuit between fuses 120.

High voltage that can break or cut each of the fuses 120 may be generated when a short circuit occurs in any portion of the wiring harness 110 connecting the battery pack 100 with the battery management system 105 during normal operation of the battery in a vehicle. The short circuit between the battery pack 110 and the battery management system 105 may be generated by an impact or a shock due to an accident, may be generated when the coating on the wires 115 is slightly stripped off by heat due to overload, or may be generated when overvoltage is rapidly applied to battery management system 105.

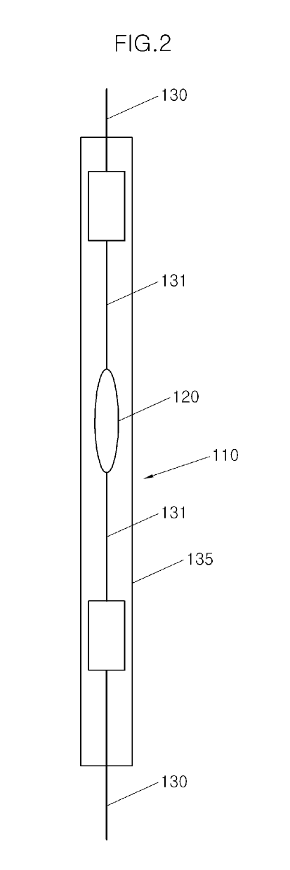

FIG. 2 is a view schematically showing the configuration of wiring harness 110 of FIG. 1. Referring to FIG. 2, the wiring harness 110 may include a plurality of high-voltage wires 130 that are separately disposed, lead wires 131 connected to high-voltage wires 130 by the fuses 120, and contacting tubes 135 that cover and fix the high-voltage wires 130, the lead wires 131, and the fuses 120. The high-voltage wire 130 of the wiring harness 110 may have a dimension that makes it possible to sufficiently transmitting power from the battery pack 100 while the lead wire 131 and the fuse 120 may have a diameter and a thickness that can withstand common voltage. For example, the fuse 120 may be 2.3 mm to 2.5 mm thick. The contracting tube 135 is made of a material that can be contracted by heat and can fix and protect the high-voltage wire 130, the lead wire 131, and the fuse 120 in the wiring harness 110 and can provide insulation as well.

Referring to FIG. 1, the wiring harness 110 may be disposed on a lower side of battery pack 100 to be easily replaced, such that it can be replaced at any time when the fuse 120 is broken or cut because the connector (not shown) is disposed as a plug-in module on both sides.

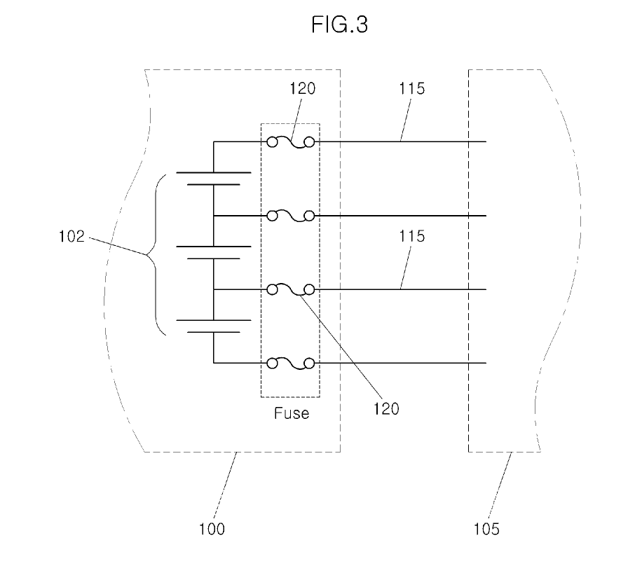

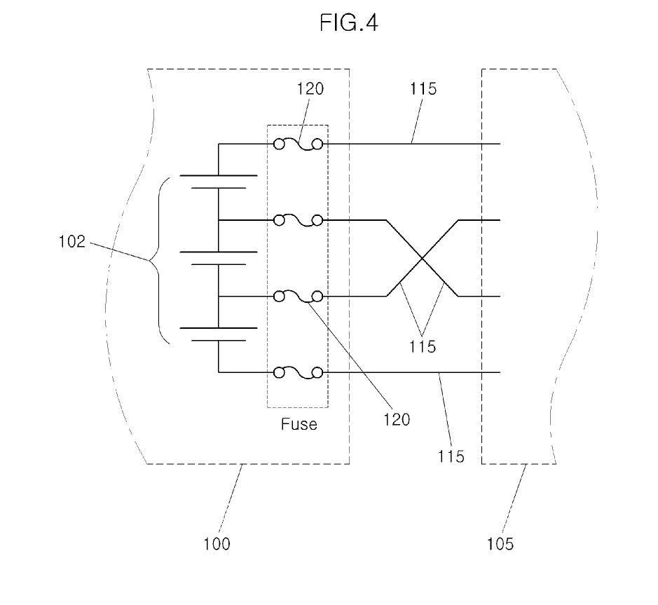

FIG. 3 is a circuit diagram of a battery cell protection device of an eco-friendly vehicle according to an exemplary embodiment of the present invention. FIG. 4 is a view showing when a short circuit has occurred in FIG. 3.

Referring to FIGS. 1, 3, and 4, a short circuit may occur in any wire 115 of the wires 115 in the wiring harness 110 between the battery pack 110 and the battery management system 105 and a high voltage may be applied to the fuse(s) 120 connecting the wires 115. One or more of the fuses 120 may be cut/broken via a high voltage and the internal circuit of the battery cell 102 and the battery management system 105 can be protected from the high voltage by disconnecting the battery pack 100 from the battery pack management system 105 in the circuit diagram. As current is shut off to the wiring harness 110, a fire that may be generated from wires 115 of wiring harness 110 can be prevented.

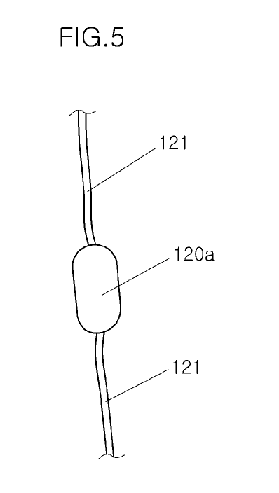

FIG. 5 is a view showing a cartridge type fuse according to an exemplary embodiment of the present invention. A cartridge type fuse 120a may be disposed and protected in a receptacle connected with the battery pack. The cartridge type fuse 120a may be provided with a wire 121 on both sides, which is connected with the receptacle (not shown).

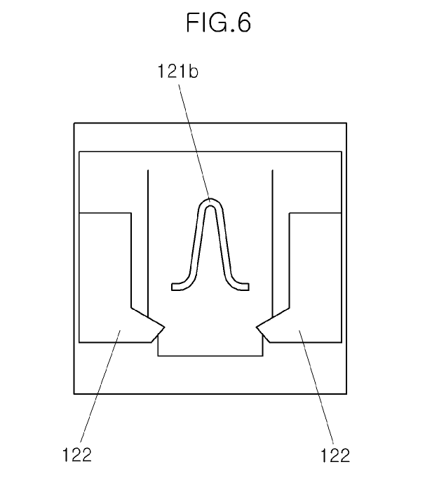

FIG. 6 is a view showing a blade type fuse 120b according to an exemplary embodiment of the present invention. The blade type fuse 120b is provided with an electrode 122 on both sides, which is connected with the battery pack, and can be cut or broken inside.

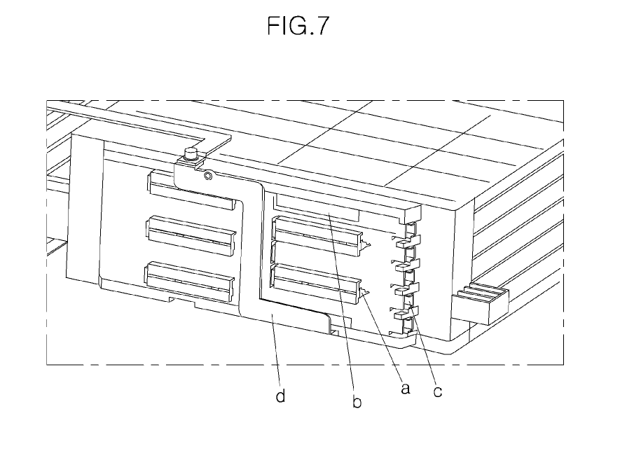

FIG. 7 is a perspective view showing a voltage sensing line of a battery pack where the cartridge type fuse and the blade type fuse according to an exemplary embodiment of the present invention can be applied. The ‘a’ is a voltage sensing terminal of the battery pack, the ‘b’ is a battery cell terminal tap, and the ‘c’ is a voltage sensing connector. The ‘d’ is a supply line connected with the battery pack, where a cartridge type fuse or a blade type fuse may be applied.

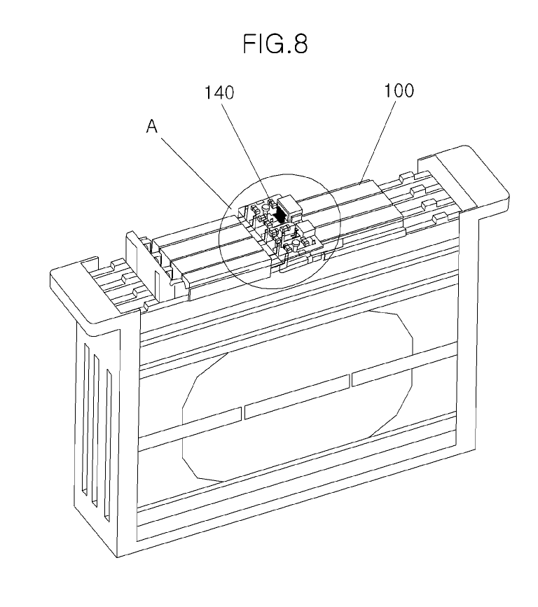

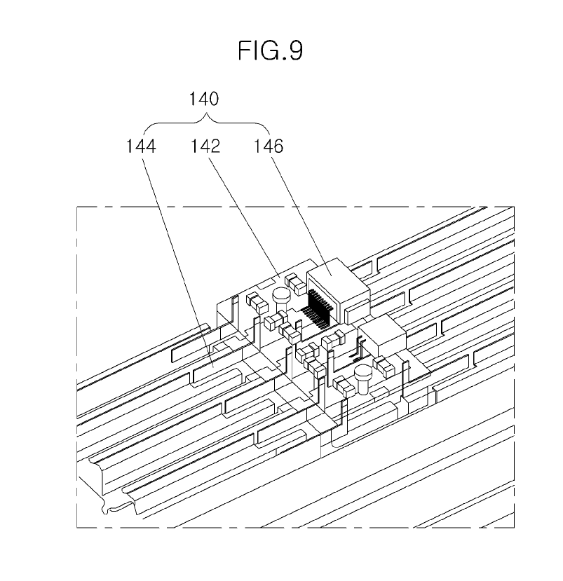

Alternatively, as a modified example according to an exemplary embodiment of the present invention, as shown in FIG. 8, a PCB (Printed Circuit Board) with a fuse may be connected one side of the battery pack 100. The PCB 140, as shown in FIG. 9, may include a bus bar 144 and a voltage sensing connector 146 for connecting a substrate 142 with the electrode of the battery pack 100.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A battery cell protection device of an eco-friendly vehicle, in a battery for a vehicle equipped with a battery pack composed of battery cells and a battery management system that manages power of the battery pack, the battery cell protection device comprising:
a wiring harness accommodating a plurality of wires connecting the battery cell with the battery management system; and
a plurality of fuses disposed within the wires of the wiring harness and configured to be cut by an abnormally high voltage,
wherein each fuse is bonded on opposite ends of the fuse to a wire in the wiring harness.

2. The battery cell protection device as defined in claim 1, wherein the wiring harness includes a plurality of high-voltage wires separately disposed, lead wires connected with the high-voltage wires by the fuses, and contracting tubes covering and fixing the high-voltage wires, the lead wires, and the plurality of fuses.

3. The battery cell protection device as defined in claim 1, wherein the wiring harness is disposed on a lower side panel of the battery pack to be replaceable.

4. The battery cell protection device as defined in claim 1, wherein the thickness of the fuse is 2.3 mm to 2.5 mm.

5. The battery cell protection device as defined in claim 1, wherein an insulator is disposed between the fuses.

6. The battery cell protection device as defined in claim 1, wherein the fuse is a cartridge type fuse.

7. The battery cell protection device as defined in claim 1, wherein the fuse is a blade type fuse.

8. The battery cell protection device as defined in claim 1, further comprising a PCB (Printed Circuit Board) that is connected with the battery pack, at a side of the battery pack, and equipped with the fuses.

9. A vehicle operating at least partially by battery power comprising:
a battery cell protection device installed in the battery of the vehicle, wherein the vehicle is equipped with a battery pack composed of battery cells and a battery management system that manages power of the battery pack, wherein the battery cell protection device includes a wiring harness accommodating a plurality of wires connecting the battery cell with the battery management system and a plurality of fuses disposed within a plurality of wires of the wiring harness wherein each of the fuses are configured to be cut by an abnormally high voltage and are bonded on opposite ends of the fuse to one of the plurality of wires in the wiring harness.

10. The vehicle as defined in claim 9, wherein the wiring harness includes a plurality of high-voltage wires separately disposed, lead wires connected with the high-voltage wires by the fuses, and contracting tubes covering and fixing the high-voltage wires, the lead wires, and the plurality of fuses.

11. The vehicle as defined in claim 9, wherein the wiring harness is disposed on a lower side panel of the battery pack to be replaceable.

12. The vehicle as defined in claim 9, wherein the thickness of the fuse is 2.3 mm to 2.5 mm.

13. The vehicle as defined in claim 9, wherein an insulator is disposed between the fuses.

14. The vehicle as defined in claim 9, wherein the fuse is a cartridge type fuse.

15. The vehicle as defined in claim 9, wherein the fuse is a blade type fuse.

16. The vehicle as defined in claim 9, further comprising a PCB (Printed Circuit Board) that is connected with the battery pack, at a side of the battery pack, and equipped with the fuses.
